(19) United States
(12) Patent Application Publication
(10) Pub. No.: US 2016/0188874 A1
(43) Pub. Date: Jun. 30, 2016

(54) SYSTEM AND METHOD FOR SECURE CODE ENTRY POINT CONTROL

(71) Applicant: Rubicon Labs, Inc., San Francisco, CA (US)

(72) Inventors: William V. Oxford, Austin, TX (US); John C. Pavan, Seiad Valley, CA (US)

(21) Appl. No.: 14/983,051

(22) Filed: Dec. 29, 2015

Related U.S. Application Data
(60) Provisional application No. 62/097,494, filed on Dec. 29, 2014.

(51) Int. Cl. G06F 21/54

(52) U.S. Cl. CPC G06F 21/54; G06F 2221/033

(57) ABSTRACT

Embodiments of systems and methods disclosed herein relate execution of related secure code blocks on a processor. Systems and methods include techniques by which impose a “secure code entry-point” condition for the individual code blocks to stop return oriented programming (ROP) attacks. Systems and methods include techniques for creating overall AuthCodes for a function chain based on the AuthCodes of the functions in the chain, rather than on the code itself, greatly increasing performance and security.

### CROSS-REFERENCE TO RELATED APPLICATION(S)

This application claims a benefit of priority under 35 U.S.C. §119 from Provisional Application No. 62/097,494, entitled “SYSTEM AND METHOD FOR SECURE CODE ENTRY POINT CONTROL,” filed Dec. 29, 2014, which is hereby fully incorporated by reference in its entirety, including appendices.

### TECHNICAL FIELD

This disclosure relates generally to security in computer systems. In particular, this disclosure relates to systems and methods for execution of related secure code blocks on a processor.

### BACKGROUND

Almost all secure devices that are renewable rely on executing code in a secure manner. Even though many such systems may be single-tasked without supporting interrupts, the entire secure code block that must be executed may not be loaded into the CPU Instruction Cache all at once. This fact may require that some amount of this secure code image will, at some point, be located in a non-secure memory space (i.e., memory that may be modified by some process that is not considered secure). There are many possible mechanisms that may be used to load secure code from non-secure memory into secure memory (where it can only be modified by a secure process).

However, even if the secure code block is constrained to only being sourced from secure memory, there are still other means by which an attacker can manipulate the CPU into executing otherwise secure code in a non-secure manner. One such method includes a technique that is known as “Return Oriented Programming” (ROP), where the CPU is directed to begin executing a valid and otherwise completely secure code block somewhere other than where the original programmer had intended. This known attack mechanism is widespread and there are even ROP compilers available that will take as input a given algorithm and a collection of otherwise secure code blocks and use them to create a collection of chained code blocks that can execute securely on a given system but in a manner that was not intended by the secure code author.

Thus, it is desirable to have a methods and systems by which a set of secure code blocks may be implemented in a manner that maintains the integrity of not only the code blocks themselves, but also the intended overall functionality of the secure application itself.

### SUMMARY OF THE DISCLOSURE

Embodiments of systems and methods for execution of related secure code blocks on a processor are disclosed.

In particular, in one embodiment, methods for execution of related secure code blocks on a processor impose a “secure code entry-point” condition for all of the individual code blocks. All other code blocks in a particular chain will then be designated as “medial” code blocks and may only be executed securely if they are called from another code block that is already executing in secure mode.

In other embodiments, methods for execution of related secure code blocks on a processor create overall AuthCodes for a function chain based on the AuthCodes of the functions in the chain, rather than on the code itself, greatly increasing performance and security.

In other embodiments, methods for execution of related secure code blocks on a processor provide AuthCodes that distinguish between code blocks called by a secured function and called by a non-secured function.

In other embodiments, methods and systems are provided by which a set of secure code blocks are be implemented in a manner that maintains the integrity of not only the code blocks themselves, but also the intended overall functionality of the secure application itself. This may be accomplished by imposing calling chain restrictions on the secure code blocks. Some embodiments are able to distinguish between a simple (and by design) algorithm or data-dependent re-arrangement of the execution order of a particular chain of secure code blocks and one where the secure code is called in an unintentional and possibly malicious order.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 depicts an architecture for content distribution according to some embodiments.

FIG. 2 depicts a target device according to some embodiments.

FIG. 3 depicts a block diagram illustrating a chain of secure library functions forming a secure atomic function according to some embodiments.

FIG. 4 depicts a block diagram of an exemplary secure mode data flow according to some embodiments.

FIGS. 5A and 5B depict exemplary secure block descriptor tables illustrating an exemplary method for creating the PACs and PACPs for a particular device according to some embodiments.

FIG. 6 depicts a block diagram of an exemplary processor architecture for a CPU used for a secure mode controller according to some embodiments.

### DETAILED DESCRIPTION

The disclosure and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

As was outlined earlier, it is desirable to have a method by which a set of secure code blocks may be implemented in a manner that maintains the integrity of not only the code blocks themselves, but also the intended overall functionality of the entire secure code block chain. In particular embodiments, this may be accomplished by imposing some kind of calling chain restrictions on the secure code blocks. However, in many cases the individual code blocks cannot simply be ordered and that order enforced since in many cases, the actual execution order cannot be determined ahead of time due to algorithmic and data-dependent branch behavior. Thus, it may be important to be able to distinguish between a simple (and by design) algorithm or data-dependent re-arrangement of the execution order of a particular chain of secure code blocks and one where the secure code is called in an unintentional and possibly malicious order.

In certain embodiments, this problem can be addressed by imposing a “secure code entry-point” condition for all of the individual code blocks. In this manner, one or more of the individual code blocks in a secure execution chain can be designated as “entry-point” code blocks. All other code blocks in a particular chain will then be designated as “medial” code blocks, which is to say that they may only be executed securely if they are called from another code block that is already executing in secure mode. Note that this “entry-point” and “medial” designation can be enforced as a part of the “control plane” (non-architectural) and can be independent of the actual code inside the candidate secure code blocks themselves.

Enforcing these “entry-point” restrictions in the control plane rather than in the actual code blocks themselves allows some important advantages. First, it allows reuse of secure code blocks in more than one application without having to re-compile the individual code blocks themselves. A second advantage is that the code blocks can be easily repartitioned without affecting the overall architecture of the algorithm itself. For example, if we wish to execute the same secure operation on two different CPUs that share a common architecture but which have different implementations, then the code itself will not have to change, even though one implementation may have a different Instruction Cache page size than the other. Another advantage of this control-plane approach is that it can make it easier to implement both code block re-entrance features as well as secure interrupt capabilities in a secure system with minimal adjustments on the initial algorithmic development.

As will be outlined below, embodiments are provided for a secure code entry point system that can be updated remotely, using a recursive security authentication mechanism. Two basic options are discussed: an “address-based” option and a “launch-time” option, although there may be other similar mechanisms or combinations of such mechanisms that may be used to accomplish the desired effect.

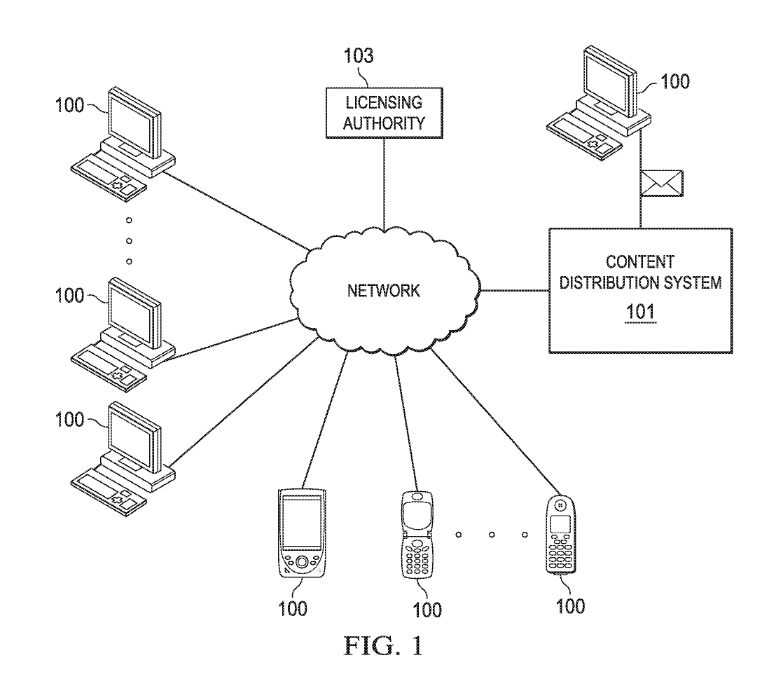

Before discussing embodiments in more detail, it may helpful to give a general overview of an architecture in which embodiments of the present invention may be effectively utilized. FIG. 1 depicts one embodiment of such a topology. Here, a content distribution system 101 may operate to distribute digital content (which may be for example, a bitstream comprising audio or video data, a software application, etc.) to one or more target units 100 (also referred to herein as target or endpoint devices) which comprise protocol engines. These target units may be part of, for example, computing devices on a wireline or wireless network or a computer device which is not networked, such computing devices including, for example, a personal computers, cellular phones, personal data assistants, media players which may play content delivered as a bitstream over a network or on a computer readable storage media that may be delivered, for example, through the mail, etc. This digital content may compose or be distributed in such a manner such that control over the execution of the digital content may be controlled and security implemented with respect to the digital content.

In certain embodiments, control over the digital content may be exercised in conjunction with a licensing authority 103. This licensing authority 103 (which may be referred to as a central licensing authority, though it will be understood that such a licensing authority need not be centralized and whose function may be distributed, or whose function may be accomplished by content distribution system 101, manual distribution of data on a hardware device such as a memory stick, etc.) may provide a key or authorization code. This key may be a compound key (DS), that is both cryptographically dependent on the digital content distributed to the target device and bound to each target device (TDn). In one example, a target device may be attempting to execute an application in secure mode. This secure application (which may be referred to as candidate code or a candidate code block (e.g., CC)) may be used in order to access certain digital content.

Accordingly, to enable a candidate code block to run in secure mode on the processor of a particular target device 100 to which the candidate code block is distributed, the licensing authority 103 must supply a correct value of a compound key (one example of which may be referred to as an Authorization Code) to the target device on which the candidate code block is attempting to execute in secure mode (e.g., supply DS1 to TD1). No other target device (e.g., TDn, where TDn≠TD1) can run the candidate code block correctly with the compound key (e.g., DS1) and no other compound key (DSn assuming DSn≠DS1) will work correctly with that candidate code block on that target device 100 (e.g., TD1).

As will be described in more detail later on herein, when Target Device 100 (e.g., TD1) loads the candidate code block (e.g., CC1) into its instruction cache (and, for example, if CC1 is identified as code that is intended to be run in secure mode), the target device 100 (e.g., TD1) engages a hash function (which may be hardware based) that creates a message digest (e.g., MD1) of that candidate code block (e.g., CC1). The seed value for this hash function is the secret key for the target device 100 (e.g., TD1's secret key (e.g., SK1)).

In fact, such a message digest (e.g., MD1) may be a Message Authentication Code (MAC) as well as a compound key, since the hash function result depends on the seed value of the hash, the secret key of the target device 100 (e.g., SK1). Thus, the resulting value of the message digest (e.g., MD1) is cryptographically bound to both the secret key of the target device 100 and to the candidate code block. If the licensing authority distributed compound key (e.g., DS1) matches the value of the message digest (e.g., MD1) it can be assured that the candidate code block (e.g., CC1) is both unaltered as well as authorized to run in secure mode on the target device 100 (e.g., TD1). The target device 100 can then run the candidate code block in secure mode.

As can be seen then, in one embodiment, when secure mode execution for a target device 100 is performed the target device 100 may be executing code that has both been verified as unaltered from its original form, and is cryptographically “bound” to the target device 100 on which it is executing. This method of ensuring secure mode execution of a target device may be contrasted with other systems, where a processor enters secure mode upon hardware reset and then may execute in a hypervisor mode or the like in order to establish a root-of-trust.

Accordingly, using embodiments as disclosed, any or all of these data such as the compound key from the licensing authority, the message digest, the candidate code block, etc. (e.g., DS1, MD1, CC1) may be completely public as longs as the secret key for the target device 100 (e.g. SK1) is not exposed. Thus, it is desired that the value of the secret key of a target device is never exposed, either directly or indirectly. Accordingly, as discussed above, embodiments of the systems and methods presented herein, may, in addition to protecting the secret key from direct exposure, protect against indirect exposure of the secret key on target devices 100 by securing the working sets of processes executing in secure mode on target devices 100.

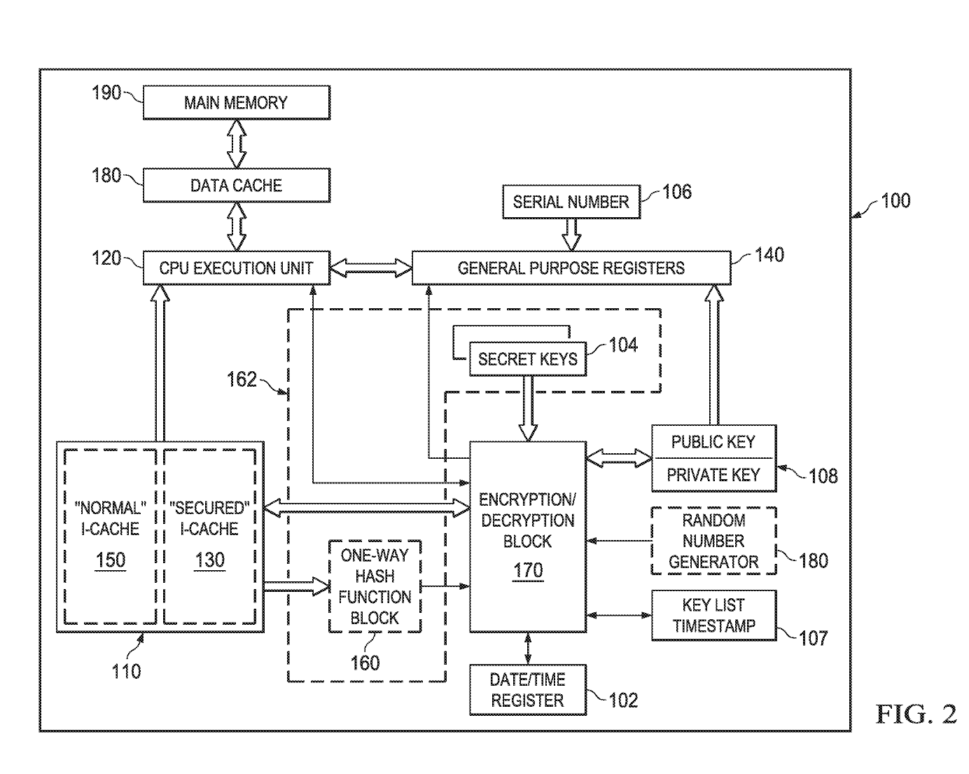

Moving now to FIG. 2, an architecture of one embodiment of a target device that is capable of controlling the execution of the digital content or implementing security protocols in conjunction with received digital content. Elements of the target unit may include a set of blocks, which allow a process to execute in a secured mode on the target device such that when a process is executing in secured mode the working set of the process may be isolated. It will be noted that while these blocks are described as hardware in this embodiment, software may be utilized to accomplish similar functionality with equal efficacy. It will also be noted that while certain embodiments may include all the blocks described herein other embodiments may utilize lesser or additional blocks.

The target device 100 may comprise a CPU execution unit 120 which may be a processor core with an execution unit and instruction pipeline. Clock or date/time register 102 may be a free-running timer that is capable of being set or reset by a secure interaction with a central server. Since the time may be established by conducting a query of a secure time standard, it may be more efficient to have this function be local; either on-chip or not requiring a network transaction. Another example of such a date/time register may be a register whose value does not necessarily increment in a monotonic manner, but whose value does not repeat very often.

Other embodiments may include a hybrid register, where a part of the register value constitutes a set of pseudo-random bits whose value is coupled with another set of bits that reflect the local time and the thus-assembled register may be signed using a private key such that the device can be confident that none of the register bits have been modified in any way. This signature can be generated in several methods, but in one embodiment a keyed-hash function can be used with the assembled register field as the input and the resulting (derived) output as the signature, where the key input that is used is a private secret that can only be accessed (although possibly not ever known) by the device that is creating the signature of the assembled register data. Another embodiment of a manner by which this signature may be implemented is to use a non-keyed hash function to generate an output that is then encrypted with the private key, as mentioned above. Thus, only a device with the ability to use this private key will be able to verify the signature.

Embodiments of such a register could be useful in the case where a unique timestamp value might be required for a particular reason, but that timestamp value could not necessarily be predicted ahead of time. Thus, a pseudo-random number generator may be a suitable mechanism for implementing such a register. Another option for implementing such a function would be to use the output of a hardware hash function 160 to produce the current value of this register. In the case where the output of such a hash function is used as a seed or salt value for the input of the hash function, the resulting output series may resemble a random number sequence statistically, but the values may nonetheless be deterministic, and thus, potentially predictable. Target unit 100 may also contain a true random number generator 182 which may be configured to produce a sequence of sufficiently random numbers or which can then be used to supply seed values for a pseudo-random number generation system. This pseudo-random number generator can also potentially be implemented in hardware, software or in “secure” software.

One-way hash function block 160 may be operable for implementing a hashing function substantially in hardware. One-way hash function block 160 may be a part of a secure execution controller 162 that may be used to control the placement of the target device 100 in secure mode or that maybe used to control memory accesses (e.g., when the target device 100 is executing in secured mode), as will be described in more detail herein at a later point.

In one embodiment, one way hash function block 160 may be implemented in a virtual fashion, by a secure process running on the very same CPU that is used to evaluate whether a given process is secure or not. In certain embodiments two conditions may be adhered to, ensuring that such a system may resolve correctly. First, the secure mode “evaluation” operation (e.g., the hash function) proceeds independently of the execution of the secure process that it is evaluating. Second, a chain of nested evaluations may have a definitive termination point (which may be referred to as the root of the “chain of trust” or simply the “root of trust”). In such embodiments, this “root of trust” may be the minimum portion of the system that should be implemented in some non-changeable fashion (e.g., in hardware). This minimum feature may be referred to as a “hardware root of trust”. For example, in such embodiments, one such hardware root of trust might be a One-Way hash function that is realized in firmware (e.g., in non-changeable software).

Another portion of the target unit 100 may be a hardware-assisted encryption/decryption block 170 (which may be referred to as the encryption system or block, the decryption system or block or the encryption/decryption block interchangeably), which may use either the target unit's 100 secret key(s) or public/private keys (described later) or a derivative thereof, as described earlier. This encryption/decryption block 170 can be implemented in a number of ways. It should also be noted that such a combination of a One-Way Hash Function and a subsequent encryption/decryption system may comprise a digital signature generator that can be used for the validation of any digital data, whether that data is distributed in encrypted or in plaintext form. The speed and the security of the entire protocol may vary depending on the construction of this block, so it may be configured to be both flexible enough to accommodate security system updates as well as fast enough to allow the system to perform real-time decryption of time-critical messages.

It is not material to embodiments exactly which encryption algorithm is used for this hardware block 170. In order to promote the maximum flexibility, it is assumed that the actual hardware is general-purpose enough to be used in a non-algorithmically specific manner, but there are many different means by which this mechanism can be implemented. It should be noted at this point that the terms encryption and decryption will be utilized interchangeably herein when referring to engines (algorithms, hardware, software, etc.) for performing encryption/decryption. As will be realized if symmetric encryption is used in certain embodiments, the same or similar encryption or decryption engine may be utilized for both encryption and decryption. In the case of an asymmetric mechanism, the encryption and decryption functions may or may not be substantially similar, even though the keys may be different.

If an asymmetric key capability is desired, but the speed of a symmetric encryption/decryption based system is desired, then one method by which this asymmetric key capability may be implemented might be to use an Identity-Based Encryption (IBE) mechanism. However, since most IBE systems are dependent on asymmetric cryptography at some point, and if speed is a desired feature, then it may be desirable to use an IBE system based on a wrapped symmetric key mechanism where the key encryption (wrapping) key is generated using the device-specific keyed hash derivative mechanism described earlier. This approach has the advantage of implementing the equivalent effect of a standard IBE system, but without resorting to asymmetric cryptographic operations. However, it may be the case that certain of these implementations can only be considered secure for certain purposes in the case where the intermediate decrypted key cannot be exported nor used for any other decryption purposes other than those for which it is designed to be used. In such cases, security may be at least partially dependent on controlling both the secure code in which this key is decrypted as well as the entry point into that code.

Target device 100 may also comprise a data cache 180, an instruction cache 110 where code that is to be executed can be stored, and main memory 190. Data cache 180 may be almost any type of cache desired such as a L1 or L2 cache. In one embodiment, data cache 180 may be configured to associate a secure process descriptor with one or more pages of the cache and may have one or more security flags associated with (all or some subset of the) lines of a data cache 180. For example, a secure process descriptor may be associated with a page of data cache 180.

Generally, embodiments of target device 100 may isolate the working set of a process executing in secure mode stored in data cache 180 such that the data is inaccessible to any other process, even after the original process terminates. More specifically, in one embodiment, the entire working set of a currently executing may be stored in data cache 180 and writes to main memory 190 and write-through of that cache (e.g., to main memory 190) disallowed (e.g., by secured execution controller 162) when executing in secured mode.

Additionally, for any of those lines of data cache 180 that are written to while executing in secure mode (e.g., a “dirty” cache line) those cache lines (or the page that comprises those cache lines) may be associated with a secure process descriptor for the currently executing process. The secure process descriptor may uniquely specify those associated “dirty” cache lines as belonging to the executing secure process, such that access to those cache lines can be restricted to only that process (e.g. be by secured execution controller 162).

In certain embodiments, in the event that the working set for a secure process overflows data cache 180 and portions of data cache 180 that include those dirty lines associated with the security descriptor of the currently executing process need to be written to main memory (e.g., a page swap or page out operation) external data transactions between the processor and the bus (e.g., an external memory bus) may be encrypted (e.g., using encryption block 170 or encryption software executing in secure mode). The encryption (and decryption) of data written to main memory may be controlled by secure execution controller 162.

The key for such an encryption may be the secure process descriptor itself or some derivative thereof and that secure descriptor may itself be encrypted (e.g., using the target device's 100 secret key 104 or some derivative thereof) and stored in the main memory 190 in encrypted form as a part of the data being written to main memory.

Instruction cache 110 is typically known as an I-Cache. In some embodiments, a characteristic of portions of this I-Cache 110 is that the data contained within certain blocks be readable only by CPU execution unit 120. In other words, this particular block of I-Cache 130 is execute-only and may not be read from, nor written to, by any executing software. This block of I-Cache 130 will also be referred to as the “secured I-Cache” 130 herein. The manner by which code to be executed is stored in this secured I-Cache block 130 may be by way of another block which may or may not be depicted. Normal I-Cache 150 may be utilized to store code that is to be executed normally as is known in the art.

Additionally, in some embodiments, certain blocks may be used to accelerate the operation of a secure code block. Accordingly, a set of CPU registers 140 may be designated to only be accessible while the CPU 120 is executing secure code or which are cleared upon completion of execution of the secure code block (instructions in the secured I-cache block 130 executing in secured mode), or if, for some reason a jump to any section of code which is located in the non-secure or “normal” I-Cache 150 or other area occurs during the execution of code stored in the secured I-Cache 130.

In one embodiment, CPU execution unit 120 may be configured to track which registers 140 are read from or written to while executing the code stored in secured I-cache block 130 and then automatically clear or disable access to these registers upon exiting the “secured execution” mode. This allows the secured code to quickly “clean-up” after itself such that only data that is permitted to be shared between two kinds of code blocks is kept intact. Another possibility is that an author of code to be executed in the secured code block 130 can explicitly identify which registers 140 are to be cleared or disabled. In the case where a secure code block is interrupted and then resumed, then these disabled registers may potentially be re-enabled if it can be determined that the secure code that is being resumed has not been tampered with during the time that it was suspended.

In one embodiment, to deal with the “leaking” of data stored in registers 140 between secure and non-secure code segments a set of registers 140 which are to be used only when the CPU 120 is executing secured code may be identified. In one embodiment this may be accomplished utilizing a version of the register renaming and scoreboarding mechanism, which is practiced in many contemporary CPU designs. In some embodiments, the execution of a code block in secured mode is treated as an atomic action (e.g., it is non-interruptible) which may make this such renaming and scoreboarding easier to implement.

Even though there may seem to be little possibility of the CPU 120 executing a mixture of “secured” code block (code from the secured I-Cache 130) and “unsecured code” (code in another location such as normal I-cache 150 or another location in memory), such a situation may arise in the process of switching contexts such as when jumping into interrupt routines, or depending on where the CPU 120 context is stored (most CPU's store the context in main memory, where it is potentially subject to discovery and manipulation by an unsecured code block).

In order to help protect against this eventuality, in one embodiment another method which may be utilized for protecting the results obtained during the execution of a secured code block that is interrupted mid-execution from being exposed to other execution threads within a system is to disable stack pushes while the target device 100 is operating in secured execution mode. This disabling of stack pushes will mean that a secured code block is thus not interruptible in the sense that, if the secured code block is interrupted prior to its normal completion, it cannot be resumed and therefore must be restarted from the beginning. It should be noted that in certain embodiments if the “secured execution” mode is disabled during a processor interrupt, then the secured code block may also potentially not be able to be restarted unless the entire calling chain is restarted.

Each target unit 100 may also have one or more secret key constants 104; the values of neither of which are software-readable. In one embodiment, the first of these keys (the primary secret key) may be organized as a set of secret keys, of which only one is readable at any particular time. If the “ownership” of a unit is changed (for example, the equipment containing the protocol engine is sold or its ownership is otherwise transferred), then the currently active primary secret key may be “cleared” or overwritten by a different value. This value can either be transferred to the unit in a secure manner or it can be already stored in the unit in such a manner that it is only used when this first key is cleared. In effect, this is equivalent to issuing a new primary secret key to that particular unit when its ownership is changed or if there is some other reason for such a change (such as a compromised key). A secondary secret key may be utilized with the target unit 100 itself. Since the CPU 120 of the target unit 100 cannot ever access the values of either the primary or the secondary secret keys, in some sense, the target unit 100 does not even “know” its own secret keys 104. These keys are only stored and used within the security execution controller 162 of the target unit 100 as will be described.

In another embodiment, the two keys may be constructed as a list of “paired” keys, where one such key is implemented as a one-time-programmable register and the other key in the pair is implemented using a re-writeable register. In this embodiment, the re-writeable register may be initialized to a known value (e.g., zero) and the only option that may be available for the system to execute in secure mode in that state may be to write a value into the re-writeable portion of the register. Once the value in this re-writeable register is initialized with some value (e.g., one that may only be known by the Licensing Authority, for example), then the system may only then be able to execute more general purpose code while in secure mode. If this re-writeable value should be re-initialized for some reason, then the use of a new value each time this register is written may provide increased security in the face of potential replay attacks.

Yet another set of keys may operate as part of a temporary public/private key system (also known as an asymmetric key system or a PKI system). The keys in this pair may be generated on the fly and may be used for establishing a secure communications link between similar units, without the intervention of a central server. As the security of such a system is typically lower than that of an equivalent key length symmetric key encryption system, these keys may be larger in size than those of the set of secret keys mentioned above. These keys may be used in conjunction with the value that is present in the on-chip timer block in order to guard against “replay attacks”, among other things. Since these keys may be generated on the fly, the manner by which they are generated may be dependent on the random number generation system 180 in order to increase the overall system security.

In one embodiment, one method that can be used to affect a change in “ownership” of a particular target unit is to always use the primary secret key as a compound key in conjunction with another key 107, which we will refer to as a timestamp or timestamp value, as the value of this key may be changed (in other words may have different values at different times), and may not necessarily reflect the current time of day. This timestamp value itself may or may not be itself architecturally visible (e.g., it may not necessarily be a secret key), but nonetheless it will not be able to be modified unless the target unit 100 is operating in secured execution mode. In such a case, the consistent use of the timestamp value as a component of a compound key whenever the primary secret is used can produce essentially the same effect as if the primary secret key had been switched to a separate value, thus effectively allowing a “change of ownership” of a particular target endpoint unit without having to modify the primary secret key itself.

As may be understood then, target device may use secure execution controller 162 and data cache 180 to isolate the working sets of processes executing in secure mode such that the data is inaccessible to any other process, even after the original process terminates. This working set isolation may be accomplished in certain embodiments by disabling off-chip writes and write-through of data cache when executing in secured mode, associating lines of the data cache written by the executing process with a secure descriptor (that may be uniquely associated with the executing process) and restricting access to those cache lines to only that process using the secure process descriptor. Such a secure process descriptor may be a compound key such as an authorization code or some derivative value thereof.

When it is desired to access data in the data cache by the process the secure descriptor associated with the currently executing process may be compared with the secure descriptor associated with the requested line of the data cache. If the secure descriptors match, the data of that cache line may be provided to the executing process while if the secure descriptors do not match the data may not be provide and another action may be taken. It should be noted that, in certain embodiments, a timestamp mechanism such as described earlier may also be used as a part of the input data of this secure descriptor to protect the unit against replay attacks.

Moreover, in certain embodiments, in the event that the working set for a secure process overflows the on-chip cache, and portions of cache that include those dirty lines associated with the secure process descriptor need to be written to main memory (e.g., a page swap or page out operation) external data transactions between the processor and the bus (e.g., an external memory bus) may be encrypted. The key for such an encryption may be the secure process descriptor itself or some derivative thereof and that secure process descriptor may be encrypted (e.g., using the target device's secret key or some derivative thereof) prior to being written out to the main memory. Again, this encryption processes may be accomplished substantially using the hashing block of the target device or by use of an software encryption process running in secure mode on the processor itself or some other on-chip processing resource, or by use of a encryption function that is implemented in hardware.

To enhance performance, in certain cases where a secure process may have a large working set or is frequently interrupted (e.g., entailing many page swaps) a subset of the processes working set that is considered “secure” may be created (e.g., only a subset of the dirty cache lines for the process may be associated with the secure descriptor) and only encrypt those cache lines or the portion of the cache containing those lines, when it is written out to external memory.

Additionally, to enhance performance, an off-chip storage mechanism (e.g., a page swapping module) can be run asynchronously in parallel with an interrupting process (e.g., using a DMA unit with integrated AES encryption hardware acceleration) and thus, could be designed to have a minimal impact on the main processor performance. In another embodiment, a separate secure “working set encapsulation” software module may be used to perform the encryption prior to allowing working set data to be written out to memory.

As outlined above, two basic options are discussed for a secure code entry point system that can be updated remotely, using a recursive security authentication mechanism, including “address-based” and “launch-time” options. The “address-based” option may, in embodiments, be the simpler of the two and this method ensures that a secure code block may only be executed from the intended entry point by including the starting address (the entry point) in the arguments to the hash function that is used to determine if the code block to be executed is, in fact, secure (discussed in more detail below). Technically, the output result of the hash function is termed a Message Authentication Code (or MAC) and in this case, these MACs are referred to as AuthCodes. Any subsequent secure code blocks that are to be executed are then prevented from being called by non-secure attackers by including a separate flag in the input data used in the calculation of their AuthCodes to indicate that the code block must be called from another secure code block (a “medial” secure code block).

It should be noted that the “address” that is used for this option is not necessarily the physical or logical address of the actual “entry-point” secure code block. In some instantiations, this entry-point “address” could simply be a sequence counter to indicate that this is the first code block in a chain of secure code blocks. Other options for this “address” data may also include an “application index” that can determine the overall functionality of a collection of secure code blocks. Thus, a secure application developer could string together previously-existing secure code blocks in order to create a new functionality from the same secure code blocks.

In embodiments employing the “launch-time” option, the input data to the hash function that is used to determine the security of a particular code block includes an additional term (potentially over and above the “entry-point” address term) in the calculation of its AuthCode. This additional term can be anything that can be used to uniquely determine the initial dispatching or “launch-time” of the overall secure application. In some cases, this could be a secure time-stamp, but in other cases a Nonce value could be used. The ability to create a secure entry-point condition that is based on a “launch-time” timestamp or Nonce allows the creation of, among other things, one-time use AuthCodes that expire immediately or after a certain number of uses, for example.

Following are more detailed examples of systems and methods for execution of related secure code blocks on a processor. Assume a system has a large library of secure functions. Perhaps a single function is only a kilobyte of code, but the entire library is several megabytes. For performance reasons, you would not want to load the entire library every time you need to verify the code.

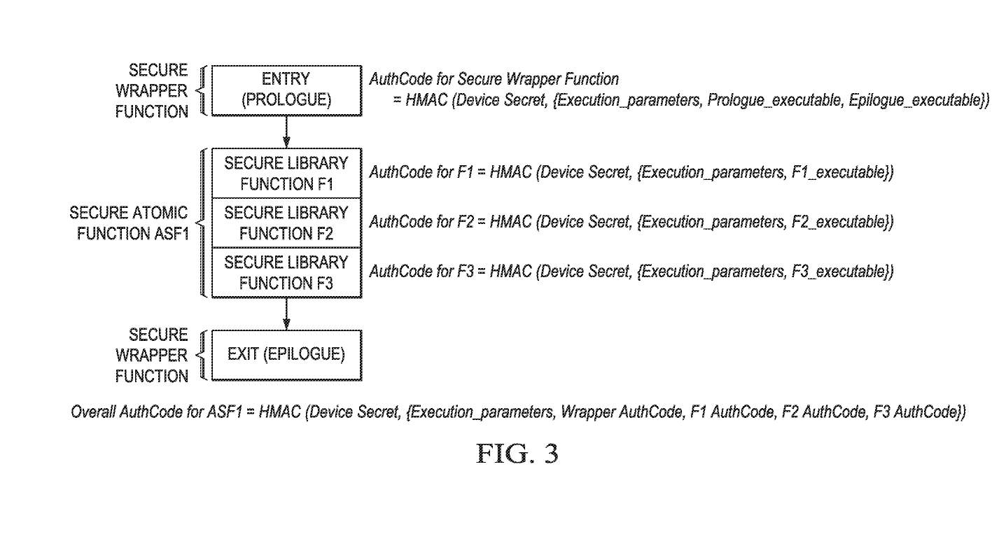

Assume a programmer wants to chain together several individual secure library functions as an atomic operation. FIG. 3 is a block diagram illustrating a chain of three secure library functions F1, F2, and F3, which together form a secure atomic function ASF1. One goal is to prevent someone from jumping directly into secure library function F2, for example, without starting at secure library function F1, then executing secure library function F2 and F3. Using techniques described below, the programmer essentially specifies the entry point (the prologue) and exit point (the epilogue) of the secure library call, and that the function should not be executable without starting with the prologue and ending with the epilogue.

In one example, a distinction is made between an AuthCode of an entry point into a secure function chain versus an AuthCode for entry point in the middle of a chain. One way to make this distinction is to add a bit to the hash function input data to create two different AuthCodes for a particular block of code. One AuthCode is for a function called by a secure function. The other AuthCode is for a function called by a non-secure function. So, there two extra pieces of information (e.g., 2 bits) needed to create the AuthCodes. One piece of information specifies whether the function is being called by a secure function, and the other is what the entry point is. When a function chain is called, information is passed along, including the entry point (i.e., the offset). In one example, the AuthCode can include an offset that defines the entry point. For example, if you start executing a piece of code from address offset 0, then that is defined as the entry point for that secure function. So, when calling a particular piece of code, the AuthCode is checked, as well as the offset into that piece of code, so both pieces of information are used to generate the AuthCode. There is a limit, defined by the secure code author, where you are allowed to jump into. In other words, the system is determining that anybody that jumps into this code must jump into the first block, and if entering anywhere else, is considered to be an attack.

Referring again to the example in FIG. 3, each secure library function F1, F2, and F3 has its own AuthCode. As illustrated in FIG. 3, each secure library function AuthCode is derived from a hash of the device secret, one or more execution parameters (discussed below), and the respective executable. As discussed above, two AuthCodes are calculated, one for when called by a secure function and one for when called by a non-secure function.

FIG. 3 also shows a secure wrapper function, comprised of the secure entry (prologue) and secure exit (epilogue). The prologue and epilogue are appended by the linker to the code stream at execution. The secure wrapper function has an AuthCode derived from a hash of the device secret, one or more execution parameters, the prologue executable, and the epilogue executable. The secure atomic function ASF1 also has its own AuthCode, which is derived from a hash of the device secret, one or more execution parameters, the secure wrapper AuthCode, the F1 AuthCode, the F2 AuthCode, and the F3 AuthCode. The ASF1 AuthCode is based on the prologue and epilogue AuthCode and the individual AuthCodes of the three secure functions. So, instead of calculating the ASF1 AuthCode based on all of the code in the secure function blocks, which could be quite large, it is calculated using the AuthCodes of the secure function blocks. A licensing authority can calculate the atomic function ASF1 AuthCode on the fly using a two-step process. First, the individual secure library function AuthCodes are calculated. Then, the ASF1 AuthCode is calculated using the library function AuthCodes and the secure wrapper AuthCode.

There are several advantages to basing the atomic function ASF1 AuthCode on the secure library function AuthCodes, rather than the actual code. First, performance is greatly increased, since the secure library function AuthCodes are small, compared the underlying code. Second, a service provider authorizing an application library from a third party developer can authorize the library without having a copy of the application code or hashed code. The third party developer can simply provide the service provider with function AuthCodes tied to the a particular device, and the service provider can create the ASF1 AuthCodes without having to see the third party developer's code.

As mentioned above, the AuthCodes for the secure library functions, the secure wrapper function, and the secure atomic function are derived using one or more execution parameters. Any desired execution parameters may be used, including, but limited to the execution parameters discussed below.

A first execution parameter is a Calling Method Flag, which specifies that the overall function may only be called by a secure mode process or by a non-secure mode process. An Entry Point range execution parameter specifies which code pages are valid entry points. By specifying the entry point, or offset, return oriented programming attacks can be stopped. An Authorized Callers List execution parameter specifies which functions may call a particular function during secure execution. An Authorized Functions List execution parameter specifies which functions may be called during secure execution. Other execution parameters are also possible, as one skilled in the art would understand.

Following is an example of a process of controlling a secure code entry point using the secure function illustrated in FIG. 3. Assume that the first function F1 has been called by a non-secured external entity. Note that this can only be entered from a non-secured entity in the first several bytes of code where variables are initialized, such as loop counters, etc. Assume that function F1 has been defined as the entry point. If a function is called from anywhere else other than the first several bytes of function F1, the process will immediately drop out of secured mode. If someone tries to jump directly into a particular secure function (such as function F2 or F3), then the AuthCode will not be calculated correctly and will not match the AuthCode provided by the licensing authority. When function F1 is called, the prologue sets up the hash to calculate the first AuthCode for Function F1. We are still in non-secure mode, so we do not trust the requester yet. If the requester is not validated, the process exits completely, or the non-secure bit is set, dropping the process out of secured mode. If the requester is correctly established, the process continues executing, and goes to the second function F2, which is called by a secured mode, since the AuthCode matched. Note that the prologue sets up all of the individual AuthCode calculations for the chain. As illustrated in FIG. 3, the overall ASF1 AuthCode depends on the library function AuthCodes, not the underlying code running inside the respective secure functions. In other words, instead of reading all the blocks of code individually (for functions F1, F2, F3), concatenating them together, and hashing them to create the AuthCode ASF1, the AuthCode ASF1 is based on concatenating just the AuthCodes of the blocks of code. As discussed above this provides several advantages relating to performance and security.

Note that it is possible that some of the AuthCodes may be calculated by some elements of the licensing authority or licensing authority cloud, and the overall AuthCode ASF1 could be calculated by a completely different cloud. Since the AuthCodes are public, it doesn't matter that these AuthCodes may be computed by one cloud and sent in the clear to another cloud for calculation of the overall AuthCode ASF1.

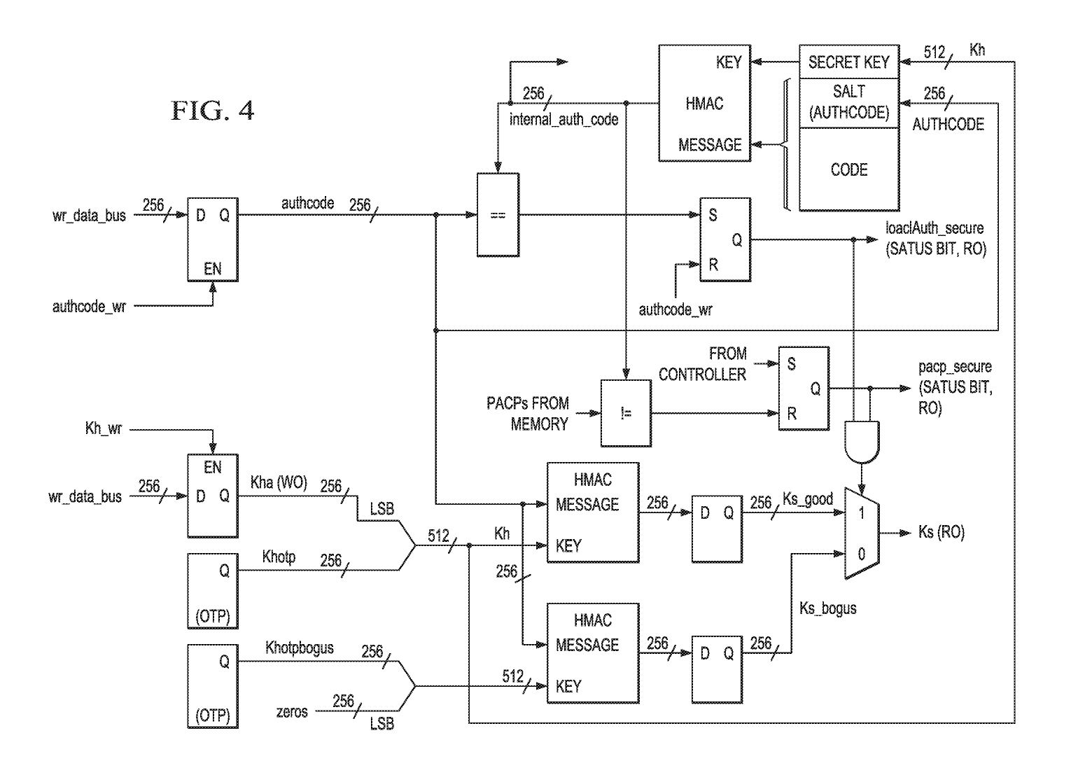

The following paragraphs describe embodiments of a mechanism that can be used to implement the “address-based” Secure Code Entry Point functionality. There are many possible other embodiments of this particular implementation that will be realized from a review of these paragraphs and FIGS. 4-6. These embodiments may accomplish the same desired effect as the examples described above, and are merely an example is just one embodiment. As such, any restrictive language or other limiting features should be understood to apply only to this embodiment. Similarly, the “launch-time” option can be implemented using an additional term (such as a Nonce) to the input of the Hash function, as will be understood from a review of the following paragraphs and FIGS. 4-6.

FIG. 4 is a block diagram of a secure mode data flow illustrating an example of creating an AuthCode in a secure mode controller. The example of FIG. 4 is merely one example implementation using a specific piece of hardware. The techniques describe above may be implemented in any desired manner.

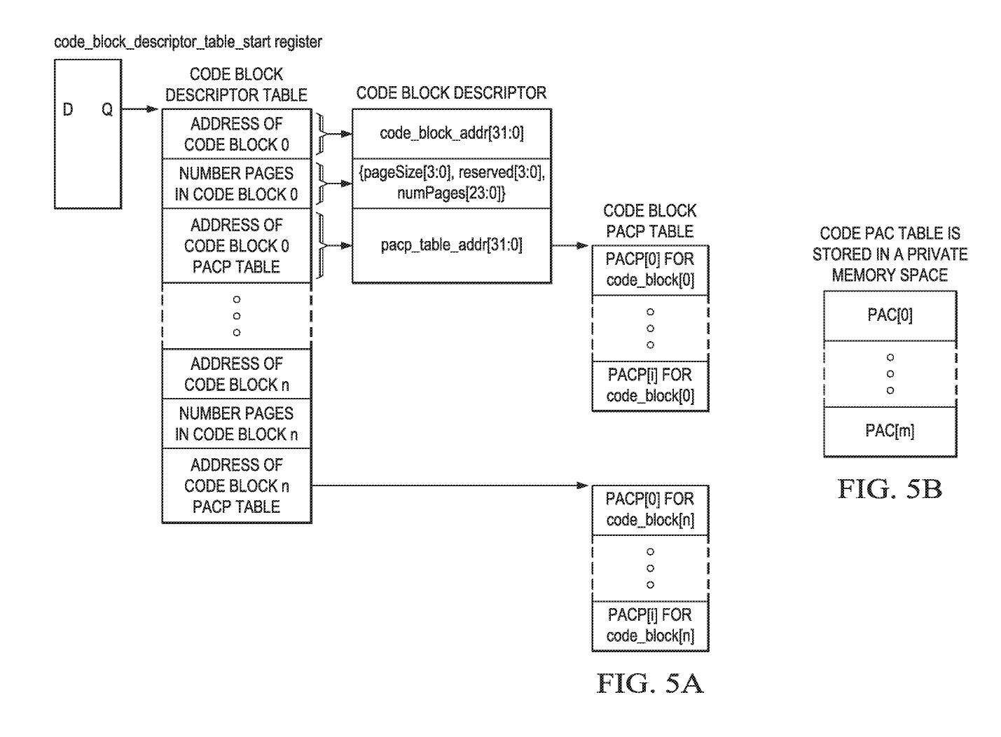

Before discussing the secure mode data flow note the following:
Kh=target specific key register is 2 registers, one static value (one time programmable) and one write only value.
The diagram of FIG. 4 is an abstract data flow, not the actual hardware data path. In some embodiments, there is one SHA256 hardware block in the secure code processing logic. It is used by the code execution State Machine and controller. A second SHA256 hardware block is used in the hardware instruction engine (see FIG. 5). This allows secure code execution to run in parallel with hardware instructions with good performance
Kha is battery backed up in an ASIC. In an FPGA we emulate that by providing a wipe feature that can reset the Kha value to 0.
In some embodiments, HMAC uses the SHA256 hash function.

Generally, there is a 3-step process for generating the overall AuthCode. First, a hash is generated for the code of each of the functions F1, F2, etc. (page authentication code (PAC)). Second, the hash of each function is prepended with the device secret (page authentication code prime (PACP)). Third, the overall AuthCode (ASF1) for the atomic function is calculated. As discussed above, we've generated the hash of each code itself. Note that ideally, a developer would not want to everyone with a hash of the code. However, once prepended with the device secret (PACP), it can be freely shared, because the AuthCode cannot be determined without the device secret.

This dual-pass hashing function architecture could be used, for example, along with pre-supplied hashes provided by the secure code developer(s) to a service that had the ability to sign such hash function outputs with the target devices' private secrets. This allows the developer to supply the service with only the hash of their executable code, as opposed to having to share the actual executable. This split-hash calculation option provides not only for higher security (since the executable can be supplied to the device in encrypted form) but also more efficient operation of the service since the service then depends only on a set of code block hashes as opposed to the full secure operation executables.

Following are definitions and notes relating to FIG. 4:
Code blocks have certain specific work to do.
Code blocks are broken up in code pages.
Each code page has a PAC and a PACP.
PAC's are stored in a private memory.
PACP's are stored in main memory.
PAC=Page Authentication Code.
PAC[n]=HMAC(Kh, code-page[n]) //Kh is the key
The central licensing authority (CLA) provides the AuthCode. The AuthCode is used by HW to validate code blocks.
AuthCode=HMAC(Kh, PAC{O . . . n)) //Kh is the key
PACP=Page Authentication Code for the L1.5 secure Icache.
PACP[O]=HMAC(Kh, authcode, code-block-addr, PAC[O]) // Kh is the key.
PACP[n]=HMAC(Kh, authcode, PAC[n]) // Kh is the key, n is 1 through numPages−1
Ks is an intermediate key generated by HW.
Ks-good=HMAC(Kh, authcode) // Kh is the key
Ks-bogus=HMAC({Khotpbogus,256'bO}, authcode) //{Khotpbogus,256'bO) is the key

FIGS. 5A and 5B are KT secure block descriptor tables illustrating an exemplary method for creating the PACs and PACPs for a particular device. The PACs and PACPs are used to generate the overall AuthCode ASF1. In the example shown in FIG. 5A, the “address of code block 0”, “# pages in code block 0”, etc., are descriptors.

Following are various notes relating to FIG. 5A:
The code block descriptor table is a 2 level structure.
The first level of the table holds the address of the code block, the number of pages in the code block and a pointer to the second level table.
The second level table holds the PACP values for the code block.
Each code block descriptor is 3 words long (4 bytes per word).
Each code page must be 32 words long and may need to be padded with words that have a value of 0.
Number of PACs or PACPs=code-size (bytes)/(32(words per page)*4(bytes per word))
PACs and PACPs are each 32 bytes (256 bits)
PAC_scratch_size_for_one_code_block(bytes)=code_size(bytes)/4
PACP_table_size_for_one_code_block(bytes)=code_size(bytes)/4

Following are various notes relating to FIG. 5B:
The HW requires some working memory (scratch area) to store PAC values when computing PACP values.
PACs are 32 bytes (256 bits).
There is a PAC for each page.
Each code page is 32 code words (a word is 4 bytes).
PACs are stored in a private memory so they are never exposed to attackers. The memory used is the secure Dcache RAMS. There is enough RAM for 2048 PACs. This is sufficient for a code block size of up to 256 Kbytes.

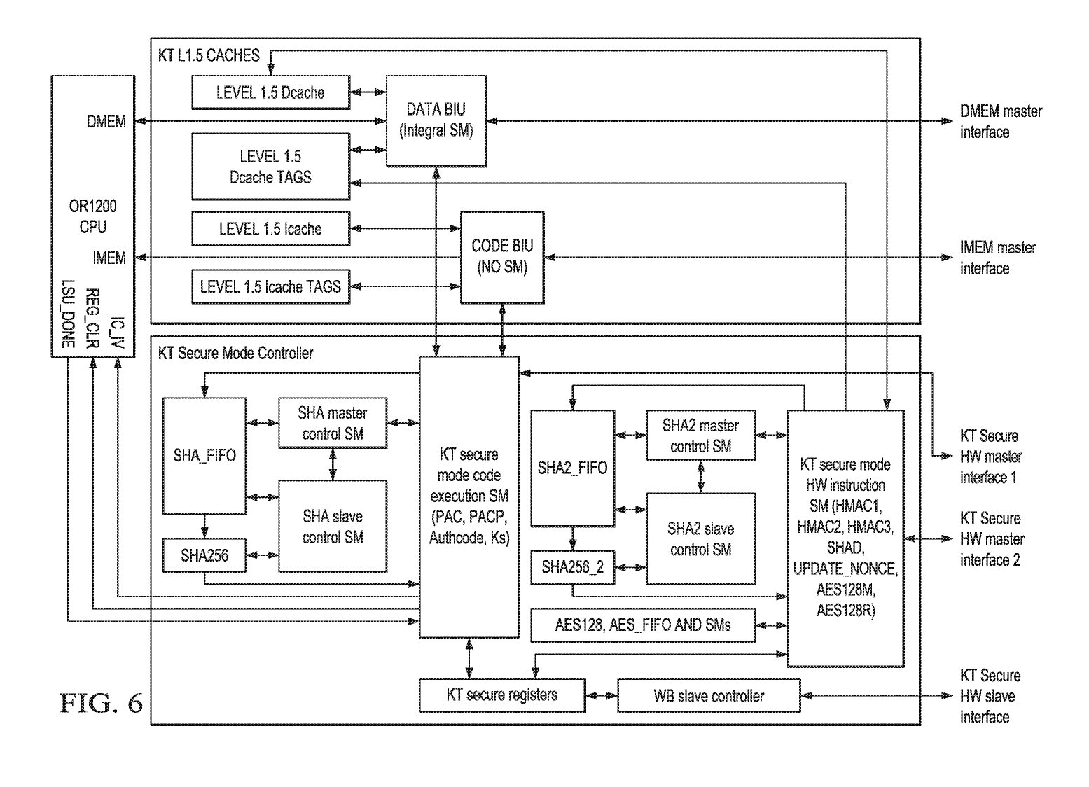

FIG. 6 is a block diagram of the processor architecture for a CPU that may be used for a secure mode controller. The diagram of FIG. 6 is merely one example, as any desired processor may be used. Following is a description of operations in the secure mode controller after issuing a PACP command and a code block RUN command.

Following are operations in the secure mode controller after issuing a PACP command:
SW will indicate a code block to authenticate by writing the code block number to a HW register and then issue a PACP command to the secure_mode_command register. The AuthCode register must be written before this command is issued. Writing the AuthCode clears the loaclAuth-secure status bit.
The HW will fetch the code block descriptor (3 words long) from the code block descriptor table. The start of the table is stored in a HW register by SW.
   Word[0] contains the address of the code block.
   Word[1] contains the page size and number of pages in the code block.
   Word[2] contains a pointer to a table where PACP values will be stored.
      A PACP value is 8 words long (256 bits).
      There is a PACP for each code page.
      Code pages are fixed at 256 bytes (32 words) currently.
The HW will generate a PAC for each code page and save it for later use
   read the code page
   generate the code page PAC value
   store each PAC of a code page in the PAC table in private memory.
The HW will generate local-authcode from the code page PACs stored in the PAC table in private memory.
The HW will compare the local AuthCode to the one sent by the CLA. If they are equal the hardware will set the loaclAuth-secure status bit in the secure_mode_status register indicating that the code block remains secure and has not been tampered with. The local AuthCode is stored in a register that is only visible to the secure HW. If the local AuthCode code compare fails an interrupt can be generated and the loaclAuth-secure status bit is not set. If the local AuthCode code compare fails the PACP table in step 6 below will not be generated and the PACP command will terminate.
The HW will generate PACPs and store them in a table in main memory for use later by the secure Icache fetch logic during the RUN command.
   read a code pages PAC from private memory
   generate a PACP using the local-AuthCode and possibly the code-block-addr.
   store the PACP in the code block PACP table
The PACP for the first code page is different then the PACP for the other code pages. PACP[O]=HMAC(Kh, AuthCode, code-block-addr, PAC[O]). PACPs for code pages other than the first are calculated as PACP[n]=HMAC(Kh, AuthCode, PAC[n]), where n is 1 through numPages−1.

Following are operations in the secure mode controller after issuing a Code Block RUN command:
SW will indicate a code block to be run by writing a command to the secure mode command register. The code block to run is specified in a register. SW will then branch to the secure code to be executed.
The HW will the set pac_prime_secure status bit.
The HW will invalidate the L1 Icache, the L1.5 Icache and the L1.5 Dcache upon entering secure mode. (If an L1 Dcache is implemented then that will be invalidated too. An L1 Dcache is not implemented in the KT OR1200 CPU based design.)
The HW will enable the L1.5 cache BIUs
The L1.5 Icache Code BIU and the KT secure mode controller validate L1.5 cache lines as they are loaded into the L1.5 Icache. The HW will complete PACP authentication for a line as it is loaded into the secure Icache.
When entering secure mode, the PACP for the first code page is calculated differently compared to the PACP for the other code pages. PACP[0]=HMAC(Kh, authcode, code_block_addr, PAC[n]), where n is 0 to numPages−1 and the pageNum, n, is determined by the instruction fetch address. PACPs for code pages other than the first are calculated as PACP[n]=HMAC(Kh, authcode, PAC[n]) where n is 1 through numPages−1 and the pageNum, n, is determined by the instruction fetch address. When checking the first PACP to enter secure mode, the instruction fetch address is used in the PACP calculation instead of the code_block_start_addr and code_page[n] is used. This guarantees that secure mode is entered at the first address of the first secure code page.
If a code page's PACP does not match then the pac_prime_secure status bit is cleared to indicate the authentication failure. An interrupt may be generated for this condition.
A PACP authentication failure will cause the HW to invalidate the L1 and L1.5 Icache lines and clear the pac-prime-secure status bit. A PACP failure will also clear the CPU general purpose regs R3-R31 and an NMI will be asserted to the CPU.
A debugger access to the HW will cause the HW to exit secure mode. In this case the HW invalidate the Icaches, clears the CPU regs and asserts the NMI similarly to a PACP failure.
A PACP authentication failure or debugger access will not allow SW to read the L1.5 Dcache tags.
A PACP authentication failure or debugger access will not allow SW to flush L1.5 Dcache lines.
A PACP authentication failure or debugger access will immediately replace the Ks value with a bogus value.
When the secure code jumps out of the secure mode code address space (range) the L1.5 and L1 Icaches will be invalidated and the RUN command will be terminated. The pac-prime-secure status bit will be cleared.
The HW monitors the code execution and when the code fetch is outside of secure space defined by the code block descriptor, secure mode will be exited automatically by the HW. In this case the HW will invalidate the L1 and L1.5 Icaches, it will clear the CPU regs (R3-R31) and it will not assert an NMI to the CPU. This is the “normal” (non-error) way to exit secure mode.
Whenever secure mode is exited due to error conditions (PACP fail or debugger access) the HW will set the secure-mode-failed status bit in the secure mode status register. The HW will also invalidate the L1 and L1.5 Icaches, it will clear the CPU regs (R3-R31) and it will assert an NMI to the CPU.
If the loaclAuth-secure bit is not set by the PACP command, the RUN command will not attempt enter secure mode.

Further, details of recursive security protocols that may be used in conjunction with the teachings herein are described in U.S. Pat. No. 7,203,844, issued Apr. 10, 2007, entitled “Recursive Security Protocol System and Method for Digital Copyright Control”, U.S. Pat. No. 7,457,968, issued Nov. 25, 2008, entitled “Method and System for a Recursive Security Protocol for Digital Copyright Control”, U.S. Pat. No. 7,747,876, issued Jun. 29, 2010, entitled “Method and System for a Recursive Security Protocol for Digital Copyright Control”, U.S. Pat. No. 8,438,392, issued May 7, 2013, entitled “Method and System for Control of Code execution on a General Purpose Computing Device and Control of Code Execution in an Recursive Security Protocol”, U.S. Pat. No. 8,726,035, issued May 13, 2014, entitled “Method and System for a Recursive Security Protocol for Digital Copyright Control”, U.S. patent application Ser. No. 13/745,236, filed Jan. 18, 2013, entitled “Method and System for a Recursive Security Protocol for Digital Copyright Control”, U.S. patent application Ser. No. 13/847,370, filed Mar. 19, 2013, entitled “Method and System for Process Working Set Isolation”, and U.S. Provisional Patent Application Ser. No. 61/882,796, filed Sep. 26, 2013, entitled “Method and System for Establishing and Using a Distributed Key Server”, U.S. Provisional Application Ser. No. 61/978,669, filed Apr. 11, 2014, entitled “System and Method for Sharing Data Securely,” and U.S. Provisional Application Ser. No. 62/074,376 filed Nov. 3, 2014, entitled “System and Method for a Renewable Secure Boot,” and U.S. patent application Ser. No. 14/683,988, filed Apr. 10, 2015, entitled “SYSTEM AND METHOD FOR AN EFFICIENT AUTHENTICATION AND KEY EXCHANGE PROTOCOL”, which are hereby incorporated by reference in their entireties for all purposes.

Although the invention has been described with respect to specific embodiments thereof, these embodiments are merely illustrative, and not restrictive of the invention. The description herein of illustrated embodiments of the invention, including the description in the Summary, is not intended to be exhaustive or to limit the invention to the precise forms disclosed herein (and in particular, the inclusion of any particular embodiment, feature or function within the Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylus, touch pad, etc.), or the like.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term (i.e., that the reference “a” or “an” clearly indicates only the singular or only the plural). Also, as used in the description herein, the meaning of “in” includes “in” and “on” unless the context clearly dictates otherwise.

What is claimed is:

1. A method of securely executing related secure code blocks on a local device comprising:
the local device generating an authorization code for each of the related secure code blocks;
the local device generating an authorization code for a secure atomic function based on the generated authorization codes for each of the related secure code blocks;
the local device receiving an authorization code for the secure atomic function from a third party; and
comparing the authorization code for the secure atomic function received from the third party with the generated authorization code for the secure atomic function.

2. The method of claim 1, wherein each of the authorization codes generated for the related secure code blocks is generated using the respective secure code block.

3. The method of claim 1, wherein each of the authorization codes generated for the related secure code blocks is generated using the respective secure code block, a device secret, and an execution parameter.

4. The method of claim 3, wherein the execution parameter defines an entry point range.

5. The method of claim 3, wherein the execution parameter specifies which functions may call a particular function during secure execution.

6. The method of claim 3, wherein the execution parameter specifies which functions can be called during secure execution.

7. The method of claim 1, wherein the authorization code generated for the secure atomic function is generated using a device secret and an execution parameter.

8. A method of securely executing related secure code blocks on a local device comprising:
the local device generating an authorization code for each of the related secure code blocks, wherein at least one of the authorization code is generated using information specifying whether the respective secure code block should be called from a secure function or a non-secure function;
the local device generating an first authorization code for a secure atomic function based on the generated authorization codes for each of the related secure code blocks;
the local device receiving an authorization code for the secure atomic function from a third party; and
comparing the authorization code for the secure atomic function received from the third party with the generated authorization code for the secure atomic function.

9. The method of claim 8, wherein each of the authorization codes generated for the related secure code blocks is generated using the respective secure code block, a device secret, and a bit indicating whether the respective secure code block should be called from a secure function or a non-secure function.

10. The method of claim 9, wherein each of the authorization codes generated for the related secure code blocks is generated using a hash function.

11. The method of claim 8, wherein each of the authorization codes generated for the related secure code blocks is generated using the respective secure code block, a device secret, and an execution parameter.

12. The method of claim 11, wherein the execution parameter defines an entry point range.

13. The method of claim 11, wherein the execution parameter specifies which functions may call a particular function during secure execution.

14. The method of claim 11, wherein the execution parameter specifies which functions can be called during secure execution.

15. A system for securely executing related secure code blocks on a local device comprising:
a processor;
a secure execution controller; and
at least one non-transitory computer-readable storage medium storing computer instructions translatable by the processor to perform:
the secure execution controller generating an authorization code for each of the related secure code blocks;
the secure execution controller generating an authorization code for a secure atomic function based on the generated authorization codes for each of the related secure code blocks;
the secure execution controller receiving an authorization code for the secure atomic function from a third party; and
comparing the authorization code for the secure atomic function received from the third party with the generated authorization code for the secure atomic function.

16. The system of claim 15, wherein each of the authorization codes generated for the related secure code blocks is generated using the respective secure code block.

17. The system of claim 15, wherein each of the authorization codes generated for the related secure code blocks is generated using the respective secure code block, a device secret, and an execution parameter.

18. The system of claim 17, wherein the execution parameter defines an entry point range.

19. The system of claim 17, wherein the execution parameter specifies which functions may call a particular function during secure execution.

20. The system of claim 17, wherein the execution parameter specifies which functions can be called during secure execution.
